(19) United States
(12) Patent Application Publication
(10) Pub. No.: US 2021/0235671 A1
(43) Pub. Date: Aug. 5, 2021

(54) MODULE FOR POULTRY FARMING CAGES

(71) Applicant: OFFICINE FACCO & C. S.P.A., CAMPO SAN MARTINO, FRAZIONE MARSANGO (IT)

(72) Inventor: Massimo FINCO, PADOVA (IT)

(73) Assignee: OFFICINE FACCO & C. S.P.A., CAMPO SAN MARTINO, FRAZIONE MARSANGO (IT)

(21) Appl. No.: 16/972,269

(22) PCT Filed: May 29, 2019
(86) PCT No.: PCT/EP2019/064048

§ 371 Date: Dec. 4, 2020

(30) Foreign Application Priority Data
Jun. 5, 2018 (IT) 102018000006028

(51) Int. Cl. A01K 31/16; A01K 31/17; A01K 39/02; A01K 39/012

(52) U.S. Cl. CPC A01K 31/165; A01K 31/17; A01K 31/002; A01K 39/0125; A01K 39/02

(57) ABSTRACT

A module for poultry farming cages, to be inserted in a cage for egg-laying hens which is provided with a bottom which is inclined toward a lateral slot for the egress of eggs toward egg collection elements. The module comprises elements for preventing the egress of chicks through the slot and elements for providing feed dispensers and drinking troughs to the animals which are adapted to their respective growth phases.

The present invention relates to a module for poultry farming cages. Nowadays in the poultry farming sector the use is broadly widespread of large sheds inside which batteries of cages containing hens or chickens or chicks are arranged.

The sheds are conveniently provided with systems to ensure the survival of the animals, such as ventilation and heating systems, and automatic systems for distributing feed and water and for conveying eggs and litter outside. The cages inside the sheds are arranged in batteries, one over the other on metallic supporting frameworks according to a configuration of levels, in order to optimize space and costs.

Sheds built in this way are efficient from the point of view of making good use of space and of the automation systems installed in them. However, at different stages of their life, the animals have different needs and the sheds require specific layouts as a function of the age of the animal.

A situation of this type arises for example in systems for raising egg-laying hens.

Usually, in fact, in intensive systems, the life of an egg-laying hen unfolds in two different sheds and in two different types of battery.

In the first four months of life, the animal passes through the chick stage, when it does not lay eggs, and after this stage it becomes laying.

The chicks are raised in dedicated sheds and in special cages, which meet specific needs in relation to the age and size of the animal. A few days before they reach a level of maturity such that they can begin laying eggs, they are manually transferred to other sheds, adapted to egg-laying hens, and therefore adapted to the automatic collection of the eggs that will be laid.

In conventional systems, the transfer of chicks can create considerable problems.

For example, the sudden change of environment and of the systems subjects the animal to a stressful situation that affects productivity and also leads to the breakup of groups that are created from hatching. In particular, in aviaries it has been proved that animals of the same group of origin are more productive even when raised in open cages, and in this situation they are also easier to manage for their redistribution in batteries, because when they reenter the cage they return with the respective group.

Further problems that can arise in transferring the animals are the management costs and the risk of contamination and transfer of diseases from one place to another.

It is not possible for chicks to use the same cages designed for egg-laying hens, mainly because the cages for egg-laying hens have a slot on the side of the egg collection basket through which the eggs can pass in order to reach the basket, and its dimensions are such that the chicks can pass through it to get out.

Furthermore, chicks have smaller claws than those of hens and the links in the wire mesh on the bottom of the cage have openings that are too big and therefore unsuitable for chicks.

Another drawback is the fact that the systems for feeding adult animals are not compatible with the size of chicks, which have difficulty in accessing feed dispensers designed for adult hens.

The aim of the present invention is to provide a module for poultry farming cages which is capable of improving the known art in one or more of the above mentioned aspects.

Within this aim, an object of the invention is to provide a module by virtue of which the same cage can be used for the whole life of the animal, by overcoming the above mentioned drawbacks, in particular the one of feeding the chicks.

Another object of the invention is to provide a module by virtue of which the specific requirements of the animals in different stages of their life are met, using the same cage.

A further object of the present invention is to overcome the drawbacks of the known art in an alternative manner to any existing solutions.

Another object of the invention is to provide a module that is easy to implement and of low cost.

This aim and these and other objects which will become better apparent hereinafter are achieved by a module for poultry farming cages, to be inserted in a cage for egg-laying hens which is provided with a bottom which is inclined toward a lateral slot for the egress of eggs toward egg collection means, said module being characterized in that it comprises means for preventing the egress of chicks through said slot and means for providing feed dispensers and drinking troughs to the animals which are adapted to their respective growth phases.

Further characteristics and advantages of the invention will become better apparent from the description of four preferred, but not exclusive, embodiments of the module according to the invention, which are illustrated by way of non-limiting example in the accompanying drawings, wherein:

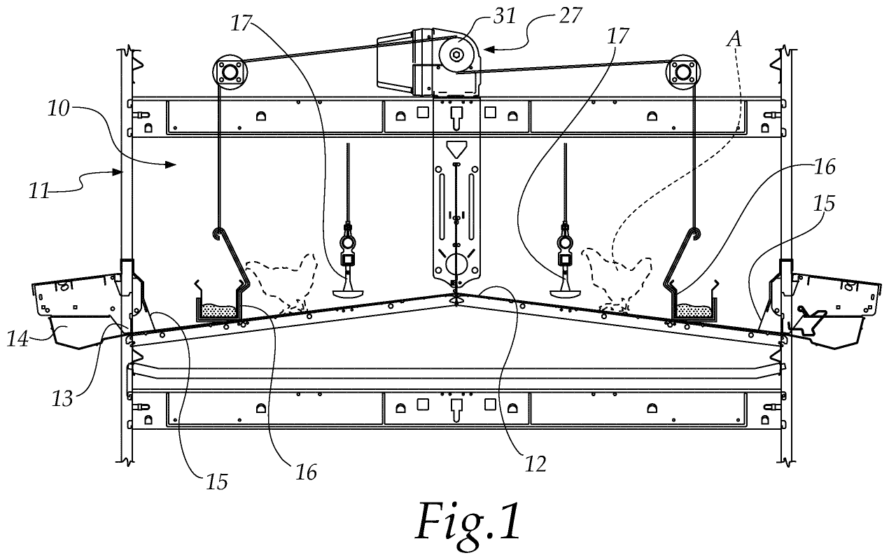

FIG. 1 is a front elevation view of a cage with the module according to the invention, in a first embodiment thereof and in use as a chicken brooding house;

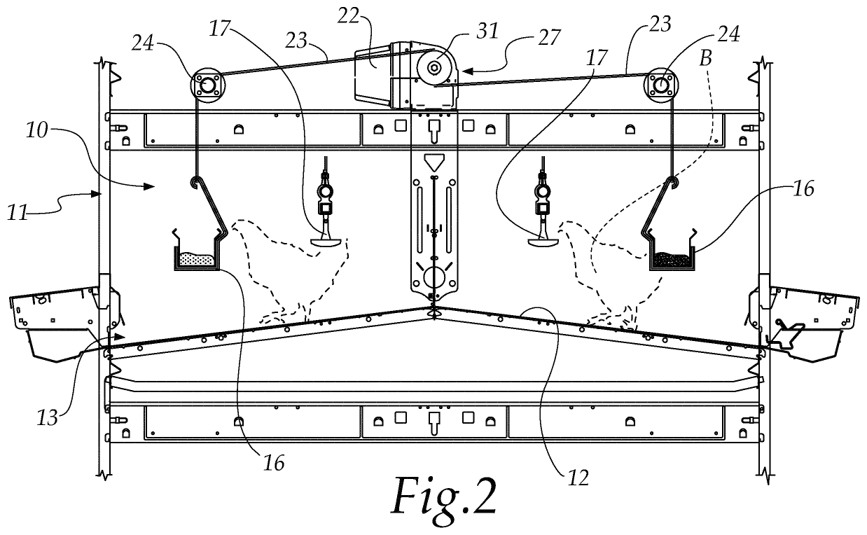

FIG. 2 is a front elevation view of the cage in FIG. 1 in use as an egg laying house;

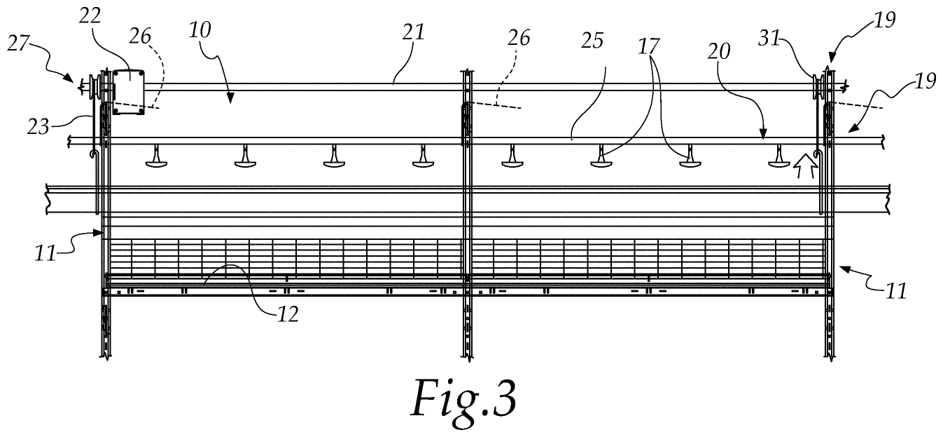

FIG. 3 is a simplified side view of the module in FIG. 1;

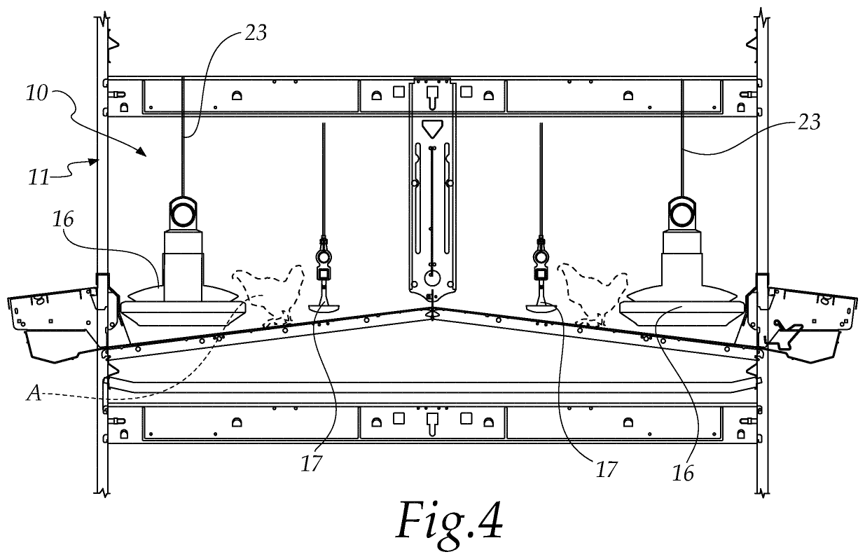

FIG. 4 is a front elevation view of a cage with the module according to the invention, in a variation of the first embodiment and in use as a chicken brooding house;

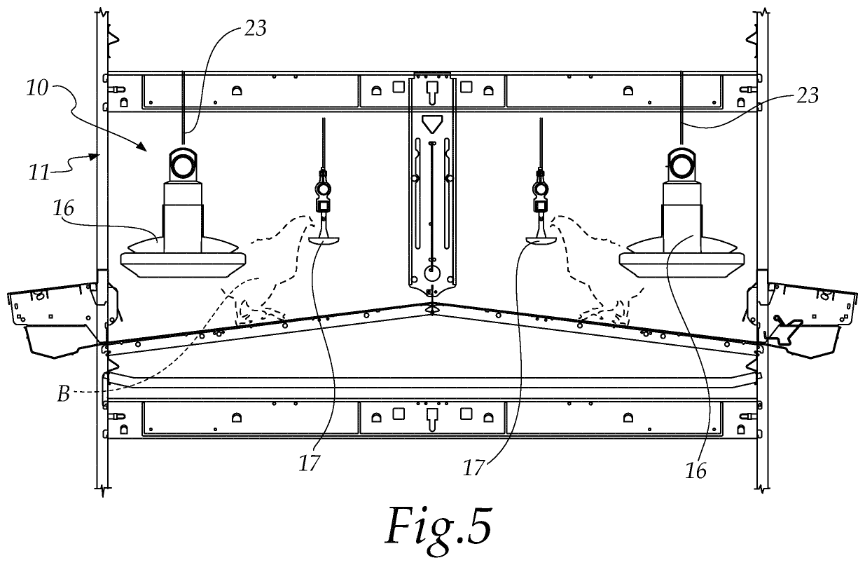

FIG. 5 is a front elevation view of the cage in FIG. 4 for the weaning of broiler animals;

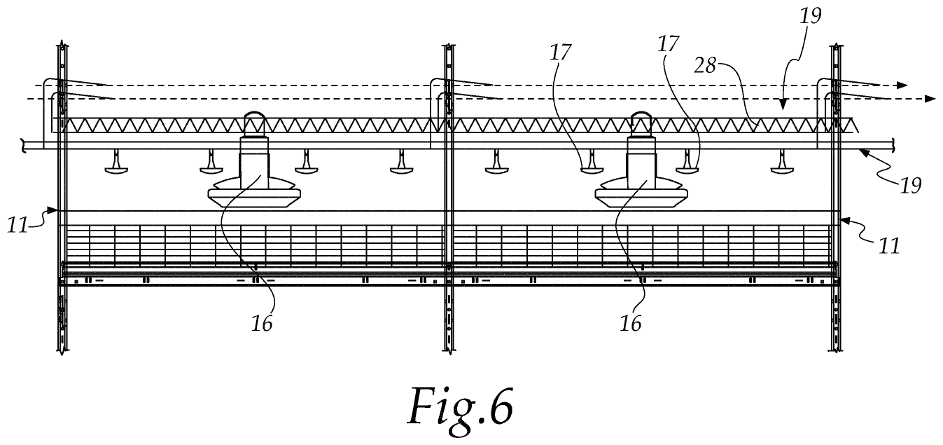

FIG. 6 is a simplified side view of the module in FIG. 4;

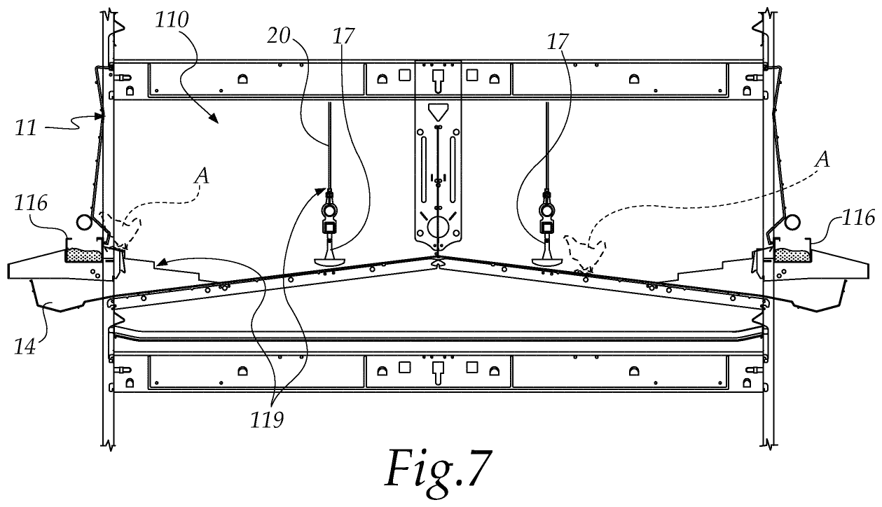

FIG. 7 is a front elevation view of a cage with the module according to the invention, in a second embodiment and in use as a chicken brooding house;

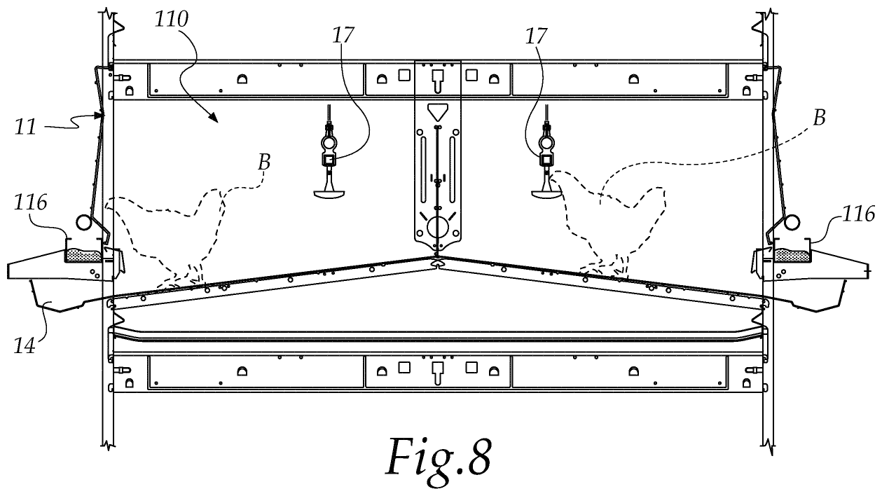

FIG. 8 is a front elevation view of the cage in FIG. 7 in use as an egg laying house;

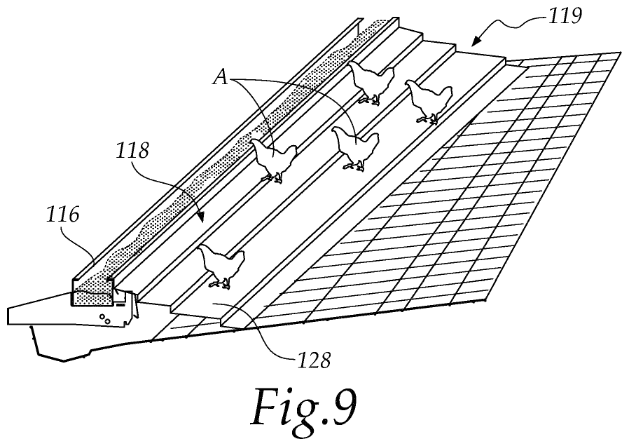

FIG. 9 is a perspective view of a detail of the module in FIG. 7;

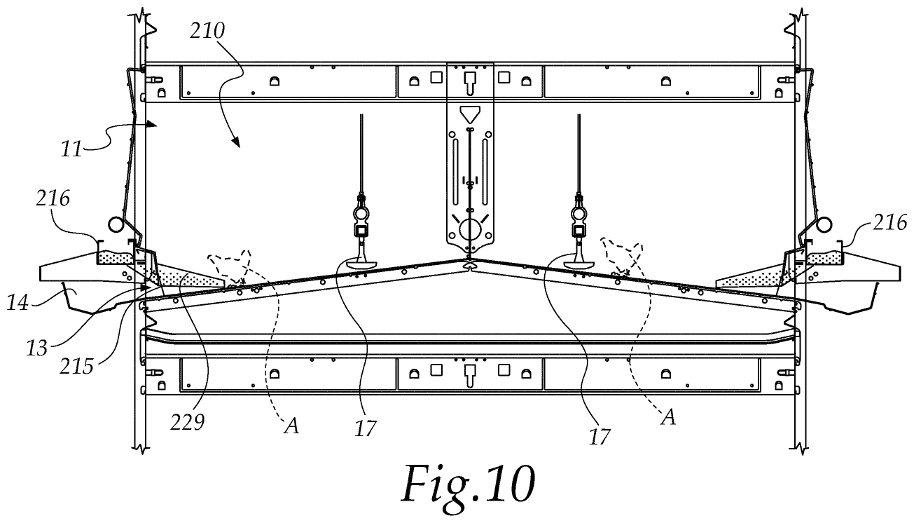

FIG. 10 is a front elevation view of a cage with the module according to the invention, in a third embodiment and in use as a chicken brooding house;

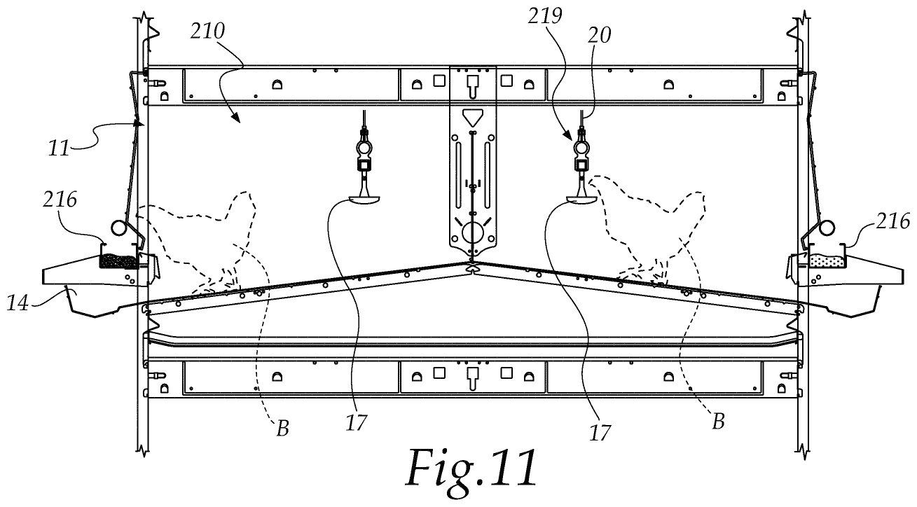

FIG. 11 is a front elevation view of the cage in FIG. 10 in use as an egg laying house;

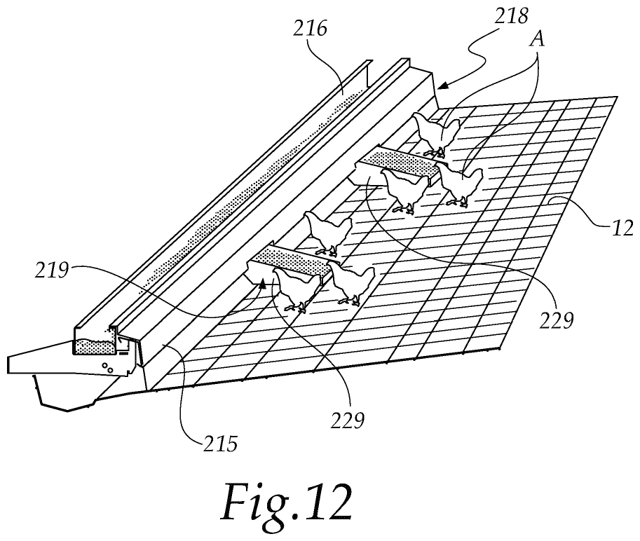

FIG. 12 is a perspective view of a detail of the module in FIG. 10;

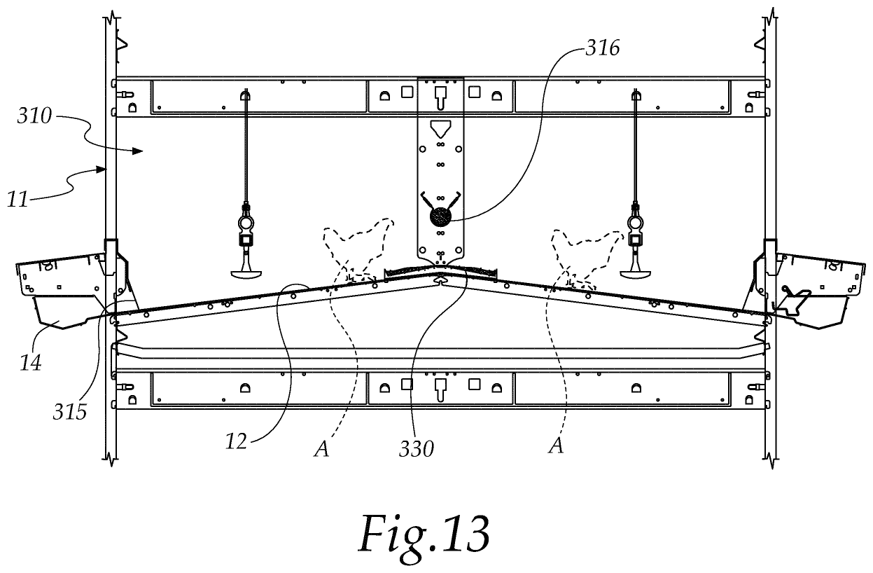

FIG. 13 is a front elevation view of a cage with the module according to the invention, in a fourth embodiment and in use as a chicken brooding house;

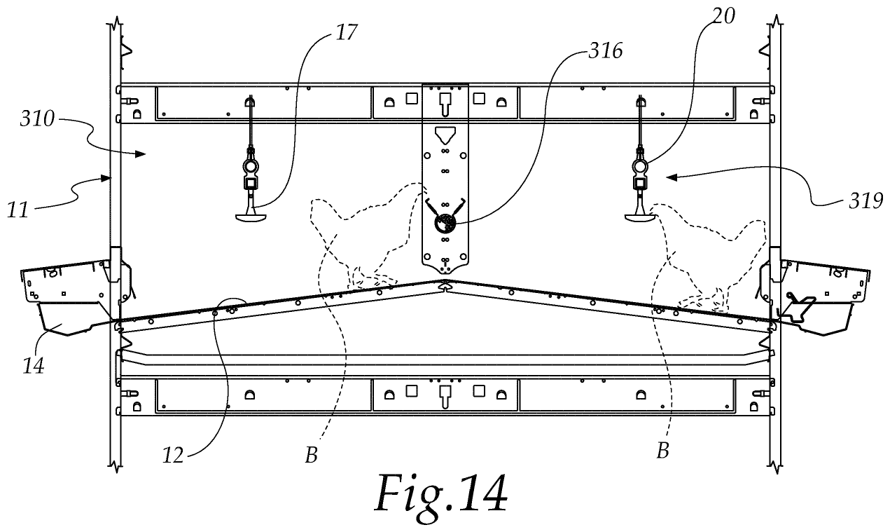

FIG. 14 is a front elevation view of the cage in FIG. 13 in use as an egg laying house;

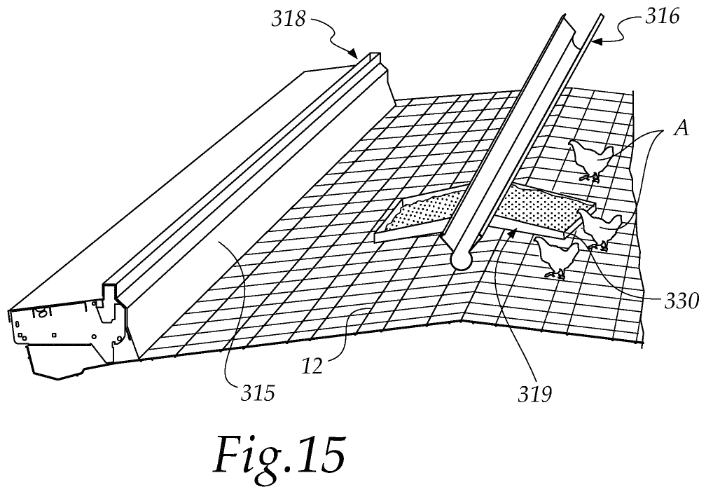

FIG. 15 is a perspective view of a detail of the module in Figure 13.

With reference to FIGS. 1 to 6, the module according to the invention is generally designated by the reference numeral 10 in its first embodiment.

Such module is adapted to be inserted into a cage 11 for egg-laying hens of the type that has a bottom 12 that is inclined toward a lateral slot 13 for the egress of the eggs toward egg collection means 14 which are installed on the cage 11 proper (outside, in the case shown), at the slot 13.

The egg collection means 14 comprise conventional baskets that extend laterally along the entire length of the cage 11. Furthermore, they can comprise a conveyor belt inside the basket for conveying the eggs out of the shed.

The module 10 also comprises an additional bottom, adapted for the chicks to walk on and to be placed above the inclined bottom 12 of the cage 11.

The additional bottom has a mesh structure, preferably in plastic with a fine mesh, i.e. with openings of smaller dimensions than those of the inclined bottom 12, which also has a mesh structure.

Alternatively, the additional bottom can be constituted by a sheet element made of a material designed to be consumed over time, mainly because of the litter released by the chicks.

In each cage 11 there are also perches (not shown in order to simplify the images), feed dispensers 16, and drinking troughs 17.

The module 10 advantageously comprises means 18 for preventing the egress of the chicks A from the slot 13, which consist of a strip 15 that extends the length of the cage 11, being adapted to cover the slot 13.

Alternatively, the additional bottom can conveniently have an edge raised upward, with which it is adapted to cover the slot 13 from the inside of the cage. Such solution can be advantageously used in the other embodiments as well, in particular in the third and in the fourth, described below, as substitution of other means for preventing the egress of the chicks.

The module 10 advantageously also comprises means 19 for providing feed dispensers 16 and drinking troughs 17 designed especially for animals in their respective growth phases.

The provision means 19 comprise a system 20 for lifting the drinking troughs 17, which is conventional for poultry farms of adult animals, and comprises a horizontal bar 25 to which the drinking troughs 17 for the animals are coupled in a downward region, and cables 26, from which the bar 25 is hung, to be pulled and released in order to raise and lower the bar.

In this first embodiment, the provision means 19 also comprise means for lifting 27 the feed dispensers 16.

In particular, in the first variation illustrated in FIGS. 1 to 3, the feed dispenser 16 is of the continuous channel type and is installed inside the cage 11.

The module 10 comprises two substantially mirror-symmetrical portions, each one of which is provided with aligned drinking troughs 17 (as in FIG. 3) and with a channel-type feed dispenser 16. A chain, not shown, slides inside the channel to convey the feed along the channel. The lifting system 27 comprises an upper shaft 21, which is kinematically connected to one or more actuation gear motors 22. The activation of the gear motors 22 is adapted to cause the winding or the unwinding of cables 23 which, being connected to the shaft 21, support the feed dispenser 16, with consequent respective raising or lowering thereof, in order to place it at the correct height for feeding the animal.

As illustrated, there being two mirror-symmetrical portions of the module 10, the shaft 21 is positioned between the two portions and at each portion there are pulleys 24 through which respective cables 23 pass which are connected to the gear motor 22. Reels 31 are keyed on the shaft 21 for winding the cables 23. The reels wind from above, as illustrated for the left-hand feed dispenser, and wind from below, as illustrated for the right-hand feed dispenser. In this manner the same gear motor 22 is able to lower and raise the feed dispensers 16 in the two portions. In fact, a single rotation causes the simultaneous winding of the two wires or their simultaneous unwinding.

The two front elevation views, FIG. 1 and FIG. 2, for comparison show the feed dispensers 16 and the drinking troughs 17 at two different heights, according to whether the modules 10 host chicks A or adult animals B.

The variation of such first embodiment, described up to this point, is illustrated in FIGS. 4 to 6 and is distinguished from the previous variation mainly by the fact that, in substitution for the channel-type feed dispensers 16, there are feed dispensers 16 of the type with a circular plate, which is conventionally used for weaning animals raised for meat (broilers).

Furthermore, with respect to the previous version described, in this case the use is preferable of a flat bottom.

As can be seen in FIG. 6, the feed dispensers 16 are suspended from a bar 28 which passes horizontally through the batteries. The bar 28 can be raised with cables 23. In this case the lifting can be done at the end of the line with systems that can be electrically motorized, hydraulic piston operated, using windlasses, endless screws etc. In any case they are adapted to pull the lifting cables 23. A second embodiment, illustrated in FIGS. 7 to 9, differs from the previous one in the type of preventing means 118, of provision means 119, and of feed dispensers 116.

In this embodiment the module is generally designated by the reference numeral 110.

The provision means 119 comprise a system 20 for lifting the drinking troughs, which is similar to that of the previous embodiment.

The feed dispenser 116 is of the channel type and is installed on the outer side of the cage 11 above the egg collection means 14. The provision means 119 comprise a staircase 128, to be placed in front of the slot, and leading to the feed dispenser 116. The staircase extends along the depth of the cage 11.

The three-dimensional shape of the staircase is clear in FIG. 9, from which it is also clear that the chicks A are facilitated in reaching the feed dispenser 116, which otherwise would be placed at a height that does not correspond to their abilities.

In this case, the staircase 128 constitutes both the provision means 119 and the means 118 for preventing the egress of the chicks A through the slot 13, since it is placed in front of the latter.

In the third embodiment, illustrated in FIGS. 10 to 12, the module is generally designated by the reference numeral 210.

The provision means 219 comprise a system 20 for lifting the drinking troughs, which is similar to those of the previous embodiments.

As in the second embodiment, the feed dispenser 216 is of the channel type and is installed on the outer side of the cage 11 above the egg collection means 14.

The preventing means 218 comprise a strip 215 like the one in the first embodiment, which extends along the length of the cage 11, being adapted to cover the slot 13.

The provision means 219 comprise additional feed dispensers 229, as an extension of the feed dispenser 216 and inclined toward the inclined bottom 12. Substantially each one of such additional feed dispensers constitutes a chute that is adapted to facilitate the fall of the feed toward the bottom, so that the chicks A can be fed.

The additional feed dispensers 229 are applied to the strip 215, which conveniently has corresponding openings. In order to allow the passage of feed from the feed dispenser 216 to the additional feed dispensers 229, the channel of the feed dispenser 216 is conveniently perforated. When the strip 215 and the additional feed dispensers 229 are removed, stopper plugs are applied on the feed dispenser 216. In the fourth embodiment, illustrated in FIGS. 13 to 15, the module is generally designated by 310.

The provision means 319 comprise a system 20 for lifting the drinking troughs, which is similar to those of the previous embodiments.

The preventing means 218 comprise a strip 215 like the one in the first embodiment, which extends along the length of the cage 11, being adapted to cover the slot 13.

The feed dispenser 316 is constituted by a substantially horizontal V-shaped channel, arranged in the central region of the cage 11 and perforated in a lower region. The provision means 319 comprise at least one plate 330 for collecting the feed, which rests on the bottom 12 and is arranged below the feed dispenser 316.

Use of the module according to the invention is the following. During the growth of the animal, the height of the drinking troughs 17 is modified as a function of the different stages of growth. When the chick A becomes an adult animal, an egg-laying hen or a broiler B, the additional bottom is extracted from the cage 11.

If the bottom is constituted by a consumable sheet element, this dissolves in the first months of the life of the animal, leaving the adult animal in contact with the inclined bottom 12.

In the first embodiment, the feed dispensers 16 are lifted during the growth of the animal and, with the removal of the strip 15, the cage 11 is already inhabitable by animals that have become adults.

In the second embodiment, when the provision means 119, i.e. the staircase 128, are extracted, the slot 13 is unblocked and the cage 11 can be inhabited by hens B for the production of eggs.

In the third and in the fourth embodiment, when the animals are in adult age, the strips 215 and 315, the additional feed dispensers 229 and the collection plates 330 are extracted, leaving more free space for the adult animals.

It is clear that, in all the embodiments, the module is capable of facilitating the animals in accessing the feed in the various different growth phases, thus facilitating correct feeding.

In particular in the first embodiment, the provision means make it possible to reduce waste feed and the quantity of feces that can fall into the feed dispenser.

Furthermore, in the second variation of the same embodiment, the module makes it possible to take advantage of known peculiarities of cages for broiler animals, in order to use cages initially intended for egg-laying hens.

In practice it has been found that the invention fully achieves the intended aim and objects by providing a module that makes it possible to use the same cage for the whole life of the animal, while ensuring that the animal can feed correctly during its growth.

The invention, thus conceived, is susceptible of numerous modifications and variations, all of which are within the scope of the appended claims. Moreover, all the details may be substituted by other, technically equivalent elements.

In practice the materials employed, provided they are compatible with the specific use, and the contingent dimensions and shapes, may be any according to requirements and to the state of the art.

The disclosures in Italian Patent Application No. 102018000006028 from which this application claims priority are incorporated herein by reference.

1.-9. (canceled)

10. A module for poultry farming cages, to be inserted in a cage for egg-laying hens which is provided with a bottom which is inclined toward a lateral slot for an egress of eggs toward egg collection means, said module further comprising means for preventing the egress of chicks through said slot and means for providing feed dispensers and drinking troughs to animals which are adapted to respective growth phases of said animals.

11. The module according to claim 10, wherein said provision means comprise at least one system for lifting at least one drinking trough.

12. The module according to claim 10, characterized in that said provision means comprise means for lifting said at least one feed dispenser.

13. The module according to claim 10, wherein said preventing means comprise a strip that extends along a length of said cage, being adapted to cover said slot.

14. The module according to claim 10, wherein said at least one feed dispenser is of the channel type, installed inside said cage.

15. The module according to claim 10, wherein said at least one feed dispenser is of the plate type.

16. The module according to claim 10, wherein said at least one feed dispenser is of the channel type, installed on an outer side of said cage above said egg collection means, said provision means comprising at least one staircase to be placed in front of said slot and leading to said feed dispenser.

17. The module according to claim 10, wherein said at least one feed dispenser is of the channel type, installed on an outer side of said cage above said egg collection means, said provision means comprising at least one additional feed dispenser, as an extension of said feed dispenser and inclined toward said inclined bottom.

18. The module according to claim 10, wherein said feed dispenser is constituted by a substantially horizontal V-shaped channel arranged in a central region of said cage and perforated in a lower region, said provision means comprising at least one plate for collecting the feed, which rests on said bottom and is arranged below said feed dispenser.
